(19) United States
(12) Patent Application Publication
(10) Pub. No.: US 2012/0235009 A1
(43) Pub. Date: Sep. 20, 2012

(54) DOOR MIRROR BASE

(75) Inventors: Hiroaki Horie, Fujieda-shi (JP); Yasuhiro Iwamoto, Fujieda-shi (JP); Toshiharu Yamashita, Fujieda-shi (JP)

(73) Assignee: MURAKAMI CORPORATION, Shizuoka (JP)

(21) Appl. No.: 13/351,602

(22) Filed: Jan. 17, 2012

(30) Foreign Application Priority Data
Mar. 17, 2011 (JP) 2011-059638

(51) Int. Cl. B60R 11/00

(52) U.S. Cl. 248/475.1

(57) ABSTRACT

A door mirror base including a base main unit for holding a vehicular door minor and a gasket disposed between the base main unit and a vehicle body. The gasket includes a hook protruding toward a vehicle body side and to be hooked onto the vehicle body. The base main unit includes a reinforcing pin passed through the gasket and protruding toward the vehicle body side of the gasket along the hook. The reinforcing pin includes a locking portion exposed on the vehicle body side of the gasket and caught by a surface of the gasket on the vehicle body side. By visually recognizing the locking portion from the vehicle body side of the gasket, it can be confirmed that the reinforcing pin is sufficiently passed through the gasket. Additionally, the locking portion makes it difficult for the reinforcing pin to be removed from the gasket.

### BACKGROUND OF THE INVENTION

1. Field of the Invention

The present invention relates to a door mirror base including a base main unit for retaining a vehicular door mirror and a gasket disposed between the base main unit and a vehicle body.

2. Related Background Art

A known door mirror base, as an example of such a door mirror base, includes a gasket and a base main unit. The gasket includes a hook-shaped temporary holding portion that protrudes toward a vehicle body side and can be hooked onto the vehicle body. The base main unit includes an inclination preventing section that is passed through the gasket and protrudes along the temporary holding portion toward the vehicle body side of the gasket (see, for example, Japanese Patent Application Laid-Open Publication No. 2003-267131).

### SUMMARY OF THE INVENTION

According to the door mirror base described in Japanese Patent Application Laid-Open Publication No. 2003-267131, the temporary holding portion is reinforced by the inclination preventing section.

The door mirror base is temporarily fixed on the vehicle body by hooking the temporary holding portion reinforced by the inclination preventing section onto the vehicle body. In the door mirror base described in Japanese Patent Application Laid-Open Publication No. 2003-267131, however, the inclination preventing section may be only insufficiently passed through the gasket. If the inclination preventing section is insufficiently passed through the gasket, inclination of the temporary holding portion causes engagement between the vehicle body and the temporary holding portion to tend to be disengaged, so that the door mirror base can be easily disengaged from the vehicle body.

An object of the present invention is to provide a door mirror base that achieves, by a hook, a temporary fixed state of being difficult to be disengaged when mounted on a vehicle body.

A door mirror base according to an aspect of the present invention includes a base main unit for holding a vehicular door mirror and a gasket disposed between the base main unit and a vehicle body, wherein the gasket includes a hook protruding toward a vehicle body side and to be hooked onto the vehicle body, the base main unit includes a reinforcing pin passed through the gasket and protruding toward the vehicle body side of the gasket along the hook, and the reinforcing pin includes a locking portion exposed on the vehicle body side of the gasket and caught by a surface of the gasket on the vehicle body side.

In the door mirror base having arrangements as described above, the door mirror base is temporarily fixed to the vehicle body by hooking the hook reinforced by the reinforcing pin onto the vehicle body. Since the reinforcing pin includes the locking portion exposed on the vehicle body side of the gasket, it can be confirmed that the hook is sufficiently reinforced by the reinforcing pin by visually recognizing the locking portion from the vehicle body side of the gasket. Additionally, the locking portion is caught by the surface of the gasket on the vehicle body side, which makes it difficult for the reinforcing pin to be removed from the gasket. As a result, the hook is firmly reinforced, so that a temporary fixed state of being difficult to be disengaged can be achieved when the vehicular door mirror is to be mounted on the vehicle body.

It is preferable that the hook have a first plane extending in a direction in which the reinforcing pin protrudes and that the reinforcing pin have a second plane facing the first plane. In this case, touching the first plane with the second plane prevents the hook being inclined relative to the reinforcing pin, so that the hook is reinforced even more firmly and the reinforcing pin is even more difficult to remove from the gasket.

Additionally, it is preferable that the hook include a pair of ribs, the ribs opposing each other in a longitudinal direction of the vehicle body across the reinforcing pin. In this case, the pair of ribs limits deviation between the hook and the reinforcing pin in the longitudinal direction of the vehicle body, so that the hook can be reinforced even more firmly.

Additionally, it is preferable that the hook have a leading end side bent downwardly of the vehicle body. In this case, the hook caught by the vehicle body is not disengaged unless the door mirror base is raised by resisting, for example, a weight of the vehicular door minor, so that a temporary fixed state of being even more difficult to be disengaged can be achieved.

As described above, in the door mirror base according to the aspect of the present invention, during mounting on the vehicle body, a temporary fixed state of being even more difficult to be disengaged can be achieved by the hook.

### BRIEF DESCRIPTION OF THE DRAWINGS

FIG. 1 is an exploded perspective view showing a door mirror base according to an embodiment of the present invention.

FIG. 2 is a perspective view showing an assembled condition of the door mirror base shown in FIG. 1.

FIG. 3 is a view on arrow III of FIG. 2.

FIG. 4 is an enlarged view showing a hook and a reinforcing pin shown in FIG. 3.

FIG. 5 is a cross-sectional view taken along line V-V of FIG. 4.

FIG. 6 is a cross-sectional view of a main section showing a condition in which the door mirror base is temporarily fixed on a vehicle body.

FIG. 7 is a cross-sectional view showing a condition in which the door mirror base is temporarily fixed on the vehicle body.

### DESCRIPTION OF THE PREFERRED EMBODIMENTS

A door mirror base according to a preferred embodiment of the present invention will be described below with reference to the accompanying drawings. In the descriptions, expressions indicating directions including upper and lower, right and left, and front and rear mean the same directions as those in a vehicle body.

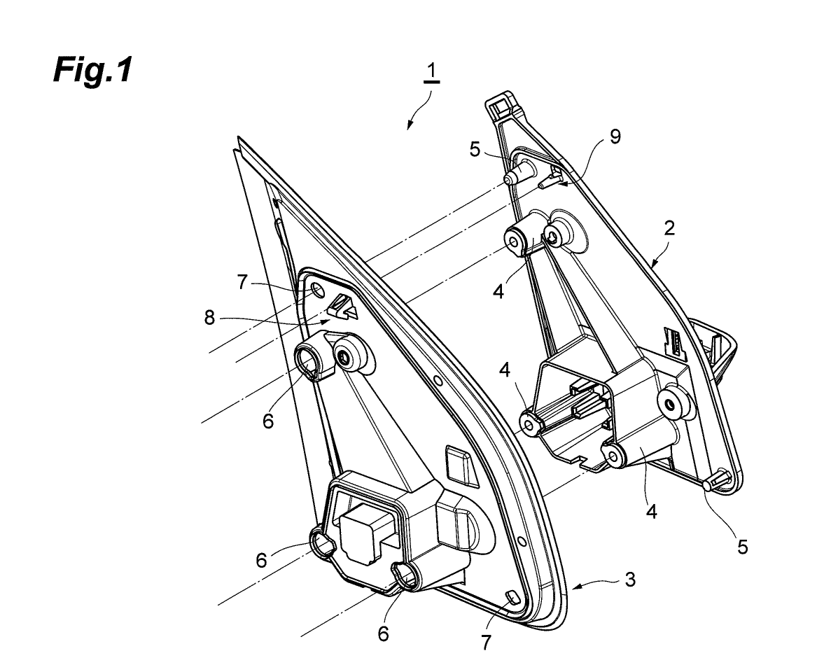

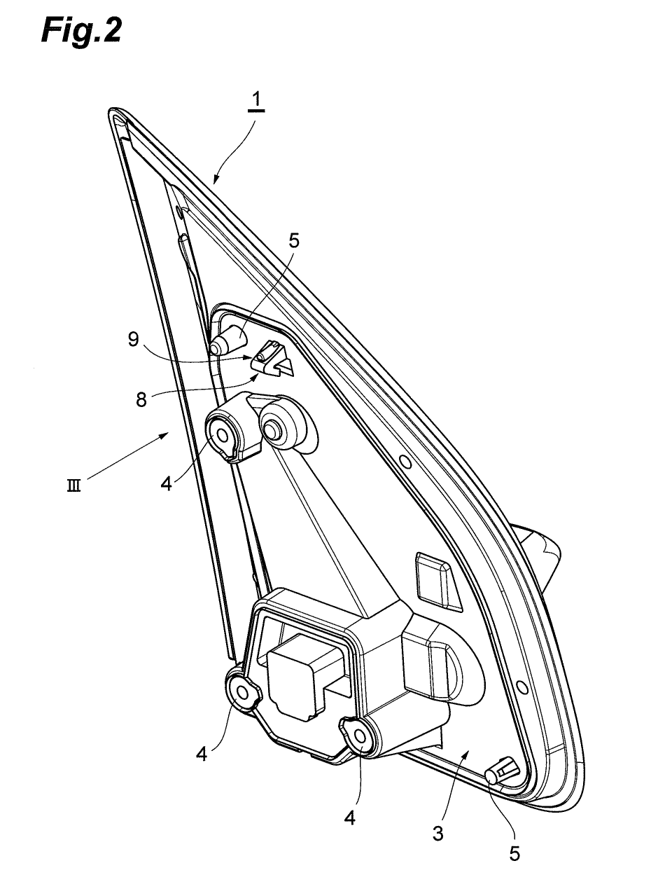

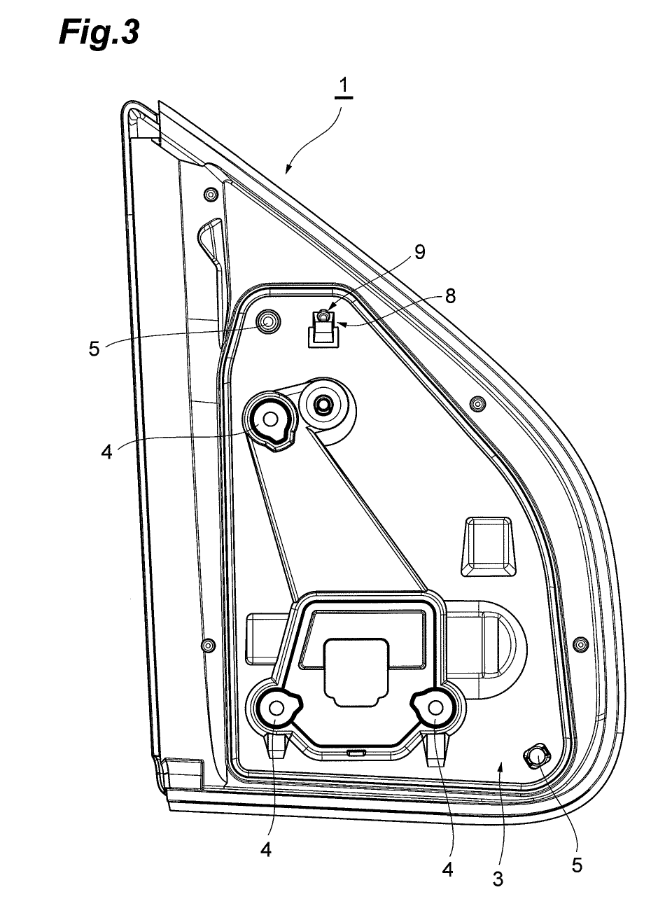

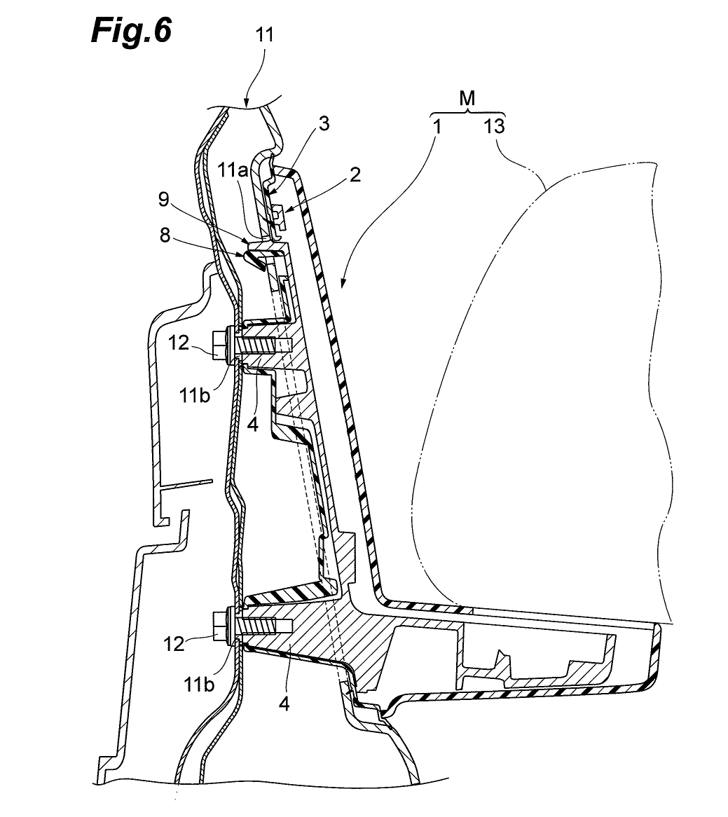

Referring to FIGS. 1 to 3, a door mirror base 1 includes a base main unit 2 formed of aluminum and a gasket 3 formed of a resin. The base main unit 2 is used for holding a mirror main unit 13 of a vehicular door mirror M (see FIG. 6), and the gasket 3 is disposed between the base main unit 2 and a vehicle body and used for hermetically sealing a gap between the base main unit 2 and the vehicle body.

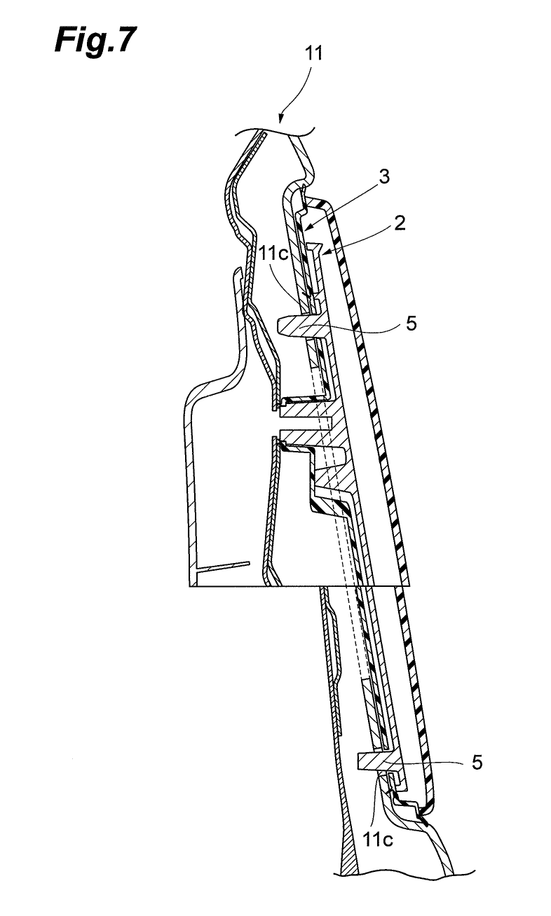

Three bolt fixing portions 4 protruding toward the vehicle body side are disposed on a back surface of the base main unit 2. A bolt 12 is threadedly engaged from the vehicle body side with each of the bolt fixing portions 4 (see FIG. 6). In addition, two positioning pins 5 protruding toward the vehicle body side are disposed on the back surface of the base main unit 2. Each of the positioning pins 5 is passed through a positioning hole 11c in the vehicle body (see FIG. 7).

The gasket 3 has bolt insertion holes 6 through which the bolts 12 are passed from the vehicle body side and positioning pin insertion holes 7 through which the positioning pins 5 are passed.

It is noted here that the gasket 3 includes a hook 8 formed at an upper portion thereof. The hook 8 protrudes toward the vehicle body side and can be hooked onto the vehicle body. A reinforcing pin 9 for reinforcing the hook 8 is formed on the back surface of the base main unit 2.

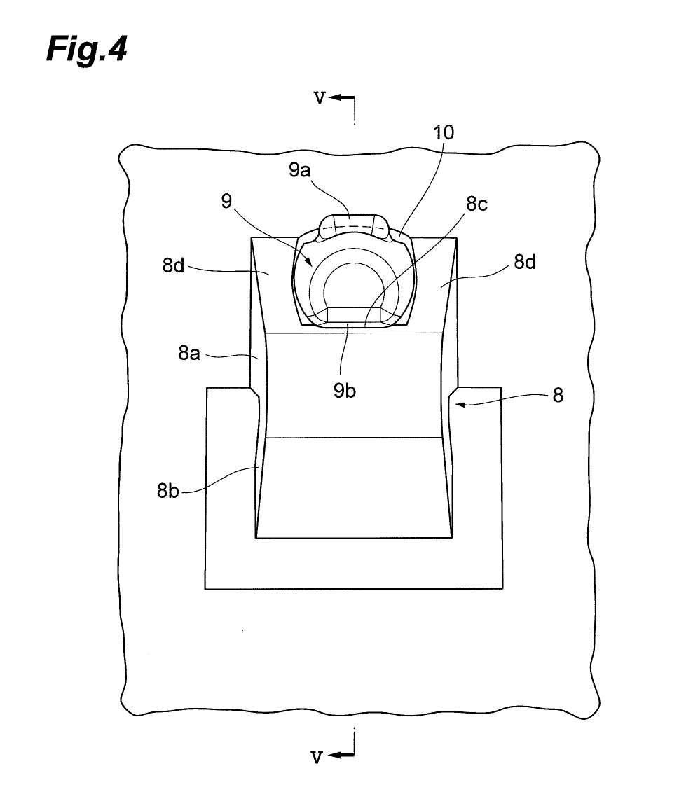

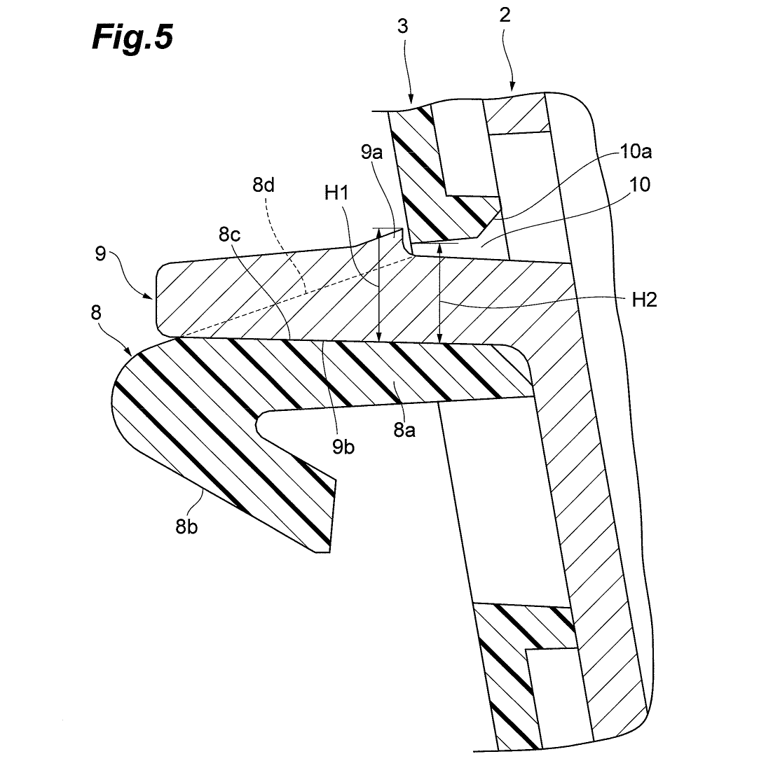

Referring to FIGS. 4 and 5, the hook 8 includes a base portion 8a and a catch portion 8b. The base portion 8a protrudes straight from the gasket 3. The catch portion 8b is bent downwardly and inwardly from a leading end of the base portion 8a. The reinforcing pin 9 is passed through a reinforcing pin insertion hole 10 formed in the gasket 3. The reinforcing pin insertion hole 10 is formed adjacent to an upper portion of the base portion 8a of the hook 8. The reinforcing pin 9 passed through the reinforcing pin insertion hole 10 extends along the hook 8 and protrudes toward the vehicle body side of the gasket 3. The reinforcing pin 9 prevents the hook 8 from being inclined upwardly.

The reinforcing pin 9 has a locking portion 9a on an outer periphery thereof. The locking portion 9a protrudes upwardly and is exposed on the vehicle body side of the gasket 3. By visually recognizing the locking portion 9a from the vehicle body side of the gasket 3, it can be confirmed that the hook 8 is sufficiently reinforced by the reinforcing pin 9.

A height H1 from a lower portion of the reinforcing pin 9 to a protruding end of the locking portion 9a is greater than a vehicle body side opening height H2 of the reinforcing pin insertion hole 10. If an attempt is made to pull the reinforcing pin 9 out of the reinforcing pin insertion hole 10, therefore, the locking portion 9a is caught by a surface of the gasket 3 on the vehicle body side at an upper portion of the reinforcing pin insertion hole 10. This makes it difficult for the reinforcing pin 9 to be removed from the reinforcing pin insertion hole 10. In addition, in order to facilitate insertion of such a reinforcing pin 9, an inclined guide surface 10a is formed at an upper portion in the opening of the reinforcing pin insertion hole 10 on the insertion side.

A protruding amount of the locking portion 9a is greater towards a base of the reinforcing pin 9. This makes small resistance when the locking portion 9a moves past the reinforcing pin insertion hole 10 after the reinforcing pin 9 advances into the reinforcing pin insertion hole 10.

This makes workability when the gasket 3 is mounted on the base main unit 2 favorable.

A first plane 8c extending in a direction in which the reinforcing pin 9 protrudes is formed on an upper portion of the base portion 8a of the hook 8. A second plane 9b that faces and touches on the first plane 8c is formed on a lower portion of the reinforcing pin 9. Touching the first plane 8c with the second plane 9b prevents the hook 8 from rotating relative to the reinforcing pin 9. As a result, the hook 8 is prevented from being inclined relative to the reinforcing pin 9, so that the hook 8 is reinforced even more firmly. Additionally, a margin of the locking portion 9a being caught (a difference between the height H1 and the height H2) is stabilized, so that the reinforcing pin 9 is even more difficult to remove from the reinforcing pin insertion hole 10.

In addition, a pair of ribs 8d is disposed at an upper portion of the base portion 8a of the hook 8. The ribs 8d oppose each other in a longitudinal direction (a crosswise direction in FIG. 4) across the reinforcing pin 9. This limits deviation between the hook 8 and the reinforcing pin 9 in the longitudinal direction, so that the hook 8 can be reinforced even more firmly.

Referring to FIG. 6, the hook 8 and the reinforcing pin 9 are passed through a temporary fixing hole 11a formed in a vehicle body 11. The catch portion 8b of the hook 8 is caught by an inner surface of the vehicle body 11 downwardly of the temporary fixing hole 11a. The door mirror base 1 is temporarily fixed to the vehicle body 11 in this manner. Since the hook 8 is firmly reinforced by the reinforcing pin 9 as described earlier, a temporary fixed state of being difficult to be disengaged can be achieved. Further, the hook 8 is caught by the inner surface of the vehicle body 11 downwardly of the temporary fixing hole 11a. As a result, the hook 8 is not disengaged unless the door mirror base 1 is raised by resisting, for example, a weight of the vehicular door mirror M, so that a temporary fixed state of being even more difficult to be disengaged can be achieved.

The door mirror base 1 is temporarily fixed as described above before being fixed in place. Specifically, the vehicular door mirror M is fixed in place in the vehicle body 11 by the bolts 12 being passed through fixing holes 11b formed in the vehicle body 11 and threadedly engaged in the bolt fixing portions 4 in the base main unit 2.

It is noted that, as shown in FIG. 7, the positioning pins 5 of the base main unit 2 are passed through the positioning holes 11c formed in the vehicle body 11. As a result, load applied to the vehicular door mirror M in vertical and longitudinal directions is borne by the positioning pins 5. Thus, the weight of the vehicular door mirror M, for example, is not to be borne only by the hook 8, so that load applied to the hook 8 and the reinforcing pin 9 can be reduced and a temporary fixed state of being even more difficult to be disengaged can be achieved.

What is claimed is:

1. A door mirror base comprising:
a base main unit for holding a vehicular door mirror; and
a gasket disposed between the base main unit and a vehicle body, wherein
the gasket includes a hook protruding toward a vehicle body side and to be hooked onto the vehicle body,
the base main unit includes a reinforcing pin passed through the gasket and protruding toward the vehicle body side of the gasket along the hook, and
the reinforcing pin includes a locking portion exposed on the vehicle body side of the gasket and caught by a surface of the gasket on the vehicle body side.

2. The door mirror base according to claim 1, wherein the hook has a first plane extending in a direction in which the reinforcing pin protrudes and the reinforcing pin has a second plane facing the first plane.

3. The door mirror base according to claim 1, wherein the hook includes a pair of ribs opposing each other in a longitudinal direction of the vehicle body across the reinforcing pin.

4. The door mirror base according to claim 1, wherein the hook has a leading end side bent downwardly of the vehicle body.
